(19) United States
(12) Patent Application Publication
(10) Pub. No.: US 2014/0272024 A1
(43) Pub. Date: Sep. 18, 2014

(54) DOUGH-MIXING CONTROL METHOD AND DEVICE CAPABLE OF DETERMINING DOUGH GLUTEN DEVELOPMENT

(71) Applicant: SINMAG EQUIPMENT CORPORATION, TAIPEI (TW)

(72) Inventor: Shuang-Yuan CHEN, Taipei (TW)

(73) Assignee: SINMAG EQUIPMENT CORPORATION, TAIPEI (TW)

(21) Appl. No.: 13/800,755

(22) Filed: Mar. 13, 2013

(51) Int. Cl. A21C 1/14

(52) U.S. Cl. CPC A21C 1/146
USPC 426/231; 366/69

(57) ABSTRACT

A dough-mixing control device capable of determining dough gluten development is mounted on a dough mixer and has a controller, a power sensor, a temperature sensor, an output module and an operation module. The controller is electrically connected to the power sensor, temperature sensor, output module and operation module. Each parameter and determination condition inputted through the operation module is transmitted to the controller. A dough gluten development determination procedure built in the controller controls temperature and gluten development of mixed dough and performs statistical calculation according to the inputted parameters and determination conditions so as to acquire the optimal gluten development of dough. Accordingly, drawbacks such as high human production cost and unstable dough quality of conventional dough mixing that relies on human experience to determine dough gluten development can be resolved.

### BACKGROUND OF THE INVENTION

1. Field of the Invention

The present invention relates to an improvement of a dough mixer and more particularly to a dough-mixing control method and device capable of determining dough gluten development during dough mixing.

2. Description of the Related Art

Conventional dough mixers for mixing or kneading dough have been equipped with a controller to set up a start/end time during dough mixing, a high/low motor speed of the dough mixer, and forward/reverse rotation of the motor of the mixing bowl. After flour, water and other ingredients are mixed, the protein in the flour interacts with the water for the flour to gradually form a piece of dough, and the gluten of the dough is also increasing. The dough determined to have the optimal ductility and elasticity can then be divided, rounded up, fermented, and baked.

In general, when dough has the highest tension of gluten, the dough also has the largest ductility and elasticity. It means that the ductility and the elasticity of the dough will be diminished if the dough is continuously mixed after optimally mixed, and bread made from such dough also lacks desired resilience. However, as far as the current technology is concerned, the controller of each dough mixer is still unable to automatically identify the optimal ductility and flexibility of dough, but relies on personal experience of operation personnel. Nevertheless, the following drawbacks occur when the mixing condition of dough is determined by human experience.

1. Inexperienced operation personnel easily misjudges the gluten development of dough and results in waste of materials and operation time.

2. When the dough mixer is operated, to constantly monitor the dough condition and prevent dough from being over or under mixed, operation personnel must always stand beside the dough mixer and pay attention to the status of dough. Therefore, the loading of operation personnel is increased while the production rate is decreased.

3. When a new product is developing, operation personnel needs to record the relationship among various dough ingredients, gluten development, mixing methods, speeds and mixing time, which may lead to confusion among the ingredients and make inconvenience for record-keeping.

4. Inconsistent dough quality arises as determinations of dough gluten development differ from person to person, and different temperatures also affect development of gluten.

5. When a dough mixer is mixing dough, the temperature of the dough will rise. If the temperature of the dough is too high, the dough may be pre-fermented to ruin the dough quality. However, conventional dough mixers fail to appropriately monitor or control the temperature of dough.

From the foregoing, using the controllers of the conventional dough mixers, high production cost, high dependence on human operation and unstable dough quality originating from the above drawbacks is very likely to occur.

Hence, as disclosed by the paper entitled “Sensing gluten development during bread dough mixing” and published by Chen-Kang Wang in 1993, a dynamic variation of the power of a mixing motor of a dough mixer is shown on a computer when the dough mixer is mixing dough and is measured by an instantaneous and non-intrusive pattern. The curve associated with the dynamic variation of the power of the mixing motor correlates with a variation of physical condition of dough. Data of the power of the mixing motor are provided to a control system for further utilization.

Also as disclosed in the paper entitled “The human decision making in the dough mixing process estimated in an artificial sensor system” and published in Journal of Food Engineering by Peter Wide in 1999, a determination system is constructed to first provide data of flour, locate an identification point in collaboration with a current signal of a motor, and incorporate a knowledge base and empirical rule to predict a proper mixing time of dough.

Another literature U.S. Pat. No. 5,472,273 entitled “System for determining the development status of a mass such as bread dough in a powered mixer” discloses that the mixer records signals of power measured from a motor and incorporated in a controller along with corresponding expert rules.

As the ingredients and the weight thereof in each dough mixing of the mixer may be different and the signals of current and power contain many noises, how to acquire information and how to effectively determine the status of dough under constantly changing conditions is still a major issue. That is why the methods in the foregoing literatures are not effectively applied in the controllers of the conventional dough mixers to develop any successful product. As a result, the controllers of current dough mixers only have simple control functions.

### SUMMARY OF THE INVENTION

An objective of the present invention is to provide a dough-mixing control method and a dough-mixing control device capable of determining dough gluten development during dough mixing.

To achieve the foregoing objective, the dough-mixing control method has a parameter configuration step, a dough temperature determination step, a dough gluten development determination step and a statistical production control step.

The parameter configuration step sets the recipe, weight, mixing time, mixing speed and elasticity of a piece of dough.

The dough temperature determination step calculates heat and temperature during the dough mixing process and further calculates a weight of added ice cubes and a weight of added cold water.

The dough gluten development determination step determines if an average current or power has reached its maximum according to a ratio of the average current or power consumed by a dough mixer within two adjacent preset time periods while mixing a piece of dough. The dough gluten development determination step further determines that an optimal condition of dough gluten of the piece of dough has been reached.

The statistical production control step records or calculates an optimal total mixing time and an optimal total mixing energy associated with each recipe. The optimal total mixing time is equal to a calculated sum of multiple mixing periods corresponding to multiple mixing speeds in the dough mixing process. The optimal total mixing energy is equal to a sum of power consumed in all the stages of the dough mixing process. Each of the optimal total mixing time and the optimal total mixing energy has a range factor for the dough gluten development determination step to determine if an actual total mixing time and an actual total mixing energy fall within a tolerance of the range factor when the piece of dough is mixed.

To achieve the foregoing objective, the dough-mixing control device is mounted on a dough mixer and has a power sensor, a temperature sensor, a micro-controller unit (MCU), a memory module, an output module and an operation module.

The power sensor is adapted to detect current or power consumed by a bowl motor and a mixer motor of the dough mixer.

The temperature sensor is adapted to detect temperature of a piece of dough inside a mixing bowl of the dough mixer.

The MCU is connected to the power sensor and the temperature sensor and has a dough gluten development determination procedure built therein. The dough gluten development determination procedure determines dough gluten development using multiple parameters and multiple gluten development determining steps to convert the gluten development into a control signal. The parameters include recipe, weight, mixing time, mixing speed and optimal temperature for the dough. The gluten development determining steps include a parameter configuration step, a dough temperature determination step, a dough gluten development determination step and a statistical production control step. The parameter configuration step sets the recipe, weight, mixing time, mixing speed and elasticity of the piece of dough. The dough temperature determination step calculates heat and temperature of the piece of dough when the piece of dough is mixed to determine if the temperature of the mixed piece of dough exceeds the optimal temperature value. The dough gluten development determination step determines if an average current or power reaches a maximum value. The statistical production control step records an optimal total mixing time and an optimal total mixing energy for a dough recipe and controls an actual total mixing time or an actual total mixing energy within a range of the optimal total mixing time or the optimal total mixing energy.

The memory module is connected to the MCU and serves to record the parameters and the gluten development determining step of the dough gluten development determination procedure.

The output module receives a control signal of the MCU and controls the mixer motors to operate according to the control signal.

The operation module is used to select or input each parameter and send it to the MCU, or display the control signal of the MCU, or the consumed current or power detected by the power sensor.

The dough gluten development determination procedure controls temperature and gluten development of mixed dough and performs statistical calculation according to the inputted parameters and determination conditions so as to acquire an optimal gluten development of dough. Accordingly, the present invention resolves drawbacks such as high human production cost and unstable dough quality of conventional dough mixing that relies on human experience to determine dough gluten development.

Other objectives, advantages and novel features of the invention will become more apparent from the following detailed description in conjunction with the accompanying drawings.

### BRIEF DESCRIPTION OF THE DRAWINGS

FIG. 1 is a perspective view of a dough mixer in accordance with the present invention;

FIG. 2 is a functional block diagram of the dough mixer in FIG. 1;

FIG. 3 is a flow diagram of a dough-mixing control method in accordance with the present invention; and

FIG. 4 is a schematic view of an operation module of the dough mixer in FIG. 1.

### DETAILED DESCRIPTION OF THE INVENTION

With reference to FIG. 1, a dough mixer in accordance with the present invention has a dough-mixing device 10 and a dough-mixing control device 20 mounted on the dough-mixing device 10.

The dough-mixing device 10 has a bowl motor 11 and a mixer motor 12. The bowl motor 11 drives a mixing bowl 13 mounted on the dough-mixing device 10 to perform forward rotation or reverse rotation. The mixer motor 12 drives a mixer 14 mounted inside the mixing bowl 13 to rotate at a high speed or a low speed. The mixer 14 serves to mix a piece of dough 30 inside the mixing bowl 13. The mixer motor 12 is an AC induction motor outputting a power (P), which is equal to a product of a torque (T) and a rotation speed (N). After the piece of dough 30 is shaped, a resistance force against rotation of the mixer 14 increases, and a load to the mixer motor 12 also increases. As AC induction motors are characterized by rotation at approximately constant speed, a consumed current of the mixer motor 12 automatically increases when the resistance against the rotation of the mixer 14 increases, so as to raise the torque outputted from the mixer motor 12 and maintain a constant rotation speed of the mixer 14.

With reference to FIG. 2, the dough-mixing control device 20 is electrically connected to the bowl motor 11 and the mixer motor 12, and has a power sensor 21, a temperature sensor 22, a micro-controller device (MCU) 23, a memory module 24, an output module 25 and an operation module 26. The MCU 23 is electrically connected to the power sensor 21, the temperature sensor 22, the memory module 24, the output module 25 and the operation module 26. The power sensor 21 is connected to an AC power source, which may be a single-phase or three-phase power supply. The output module 25 is electrically connected to the power sensor 21, the bowl motor 11 and the mixer motor 12 to control operation of the bowl motor 11 and the mixer motor 12.

The power sensor 21 serves to detect current or power consumed by the bowl motor 11 and the mixer motor 12. In the present embodiment, the power sensor 21 has an induction coil for detecting voltage and current inputted from the AC power source, obtaining current and/or power signals, and transmitting the current and/or power signals to the MCU 23.

The temperature sensor 22 serves to detect a temperature of the piece of dough 30 inside the mixing bowl 13 and transmits the temperature to the MCU 23. In the present embodiment, the temperature sensor 22 is connected to a temperature probe 221 to detect a temperature of the piece of dough 30. The temperature probe 221 may be a platinum probe (Pt100) or a thermocouple (K or J type). When the piece of dough 30 is inside the mixing bowl 13, the temperature probe 221 is used to detect the temperature of the piece of dough 30. When flour and other ingredients are not placed inside the mixing bowl 13, the temperature probe 221 can measure a temperature of an ambient environment around the dough-mixing device 10.

The MCU 23 is connected to the power sensor 21 and the temperature sensor 22 and has a dough gluten development determination procedure 231 built therein. The dough gluten development determination procedure 231 determines dough gluten development using multiple parameters and multiple gluten development determining steps to convert the gluten development into a control signal. The parameters include recipe, weight, mixing time, mixing speed and optimal temperature for the dough. With reference to FIG. 3, the gluten development determining steps include a parameter configuration step, a dough temperature determination step, a dough gluten development determination step and a statistical production control step. The parameter configuration step sets the recipe, weight, mixing time, mixing speed and elasticity of the piece of dough 30. The dough temperature determination step calculates heat and temperature of the piece of dough 30 when the piece of dough 30 is mixed to determine if the temperature of the mixed piece of dough 30 exceeds the optimal temperature value. The dough gluten development determination step determines if the average current or power reaches a maximum value. The statistical production control step records an optimal total mixing time and an optimal total mixing energy for each of the recipe.

The memory module 24 is connected to the MCU 23 and serves to record the parameters and the gluten development determining step of the dough gluten development determination procedure 231.

The output module 25 receives a control signal of the MCU 23 and controls the bowl motor 11 and the mixer motor 12 to operate according to the control signal.

With reference to FIG. 4, the operation module 26 is used to select or input each parameter and send it to the MCU 23, or display the control signal of the MCU 23, or the consumed current or power of the bowl motor 11 and the mixer motor 12 detected by the power sensor 21.

With further reference to FIG. 3, the parameter configuration step, the dough temperature determination step, the dough gluten development determination step, and the statistical production control step are described as follows.

The parameter configuration step is a step of setting parameters (Step 101). When intending to automatically determine if the dough is in its optimal condition through the dough-mixing control device 20, operation personnel must input parameters to the memory module 24 or select necessary parameters in a recipe table stored in the MCU 23 in advance. These parameters include weight of flour (F), weight of oil (O) (such as butter oil), elasticity of dough (Q) and mixing time and speed.

The dough temperature determination step determines an optimal temperature after dough mixing is completed (T_{f}, usually 27° C.). The quality and elasticity of the dough is affected if the temperature of dough is higher or lower than the optimal temperature. However, the dough-mixing device 10 has no ice water or hot water tubing to chill or heat the dough. Hence, after operation personnel inputs each parameter in the foregoing steps, the dough-mixing control device 20 calculates, then actively prompts for the weight of ice cubes (I) and the weight of cold water (W) to be added (Step 102), and starts mixing dough (Step 103). The heat acquired by the mixer 14, the mixing bowl 13 and the piece of dough 30 is calculated to be approximately equal to a total electric energy (E) inputted to the bowl motor 11 and the mixer motor 12. The heat should be divided by a thermal equivalent of work first to convert its unit from Joule (J) to calorie (Cal). The equation is expressed as follows.

[MC_{M}+FC_{F}+OC_{O}](T_{f}−Tᵣ)+ICᵢ(T_{f}−Tᵢ)+IC_{L}+WC_{W}(T_{f}−Tᵣ=E (1)

where

M: the weight of the mixer 14 and the mixing bowl 13;

C_{M}: the specific heat of a stainless steel material of the mixer 14 and the mixing bowl 13;

C_{F}, C_{O}: are the specific heats of flour (F) and oil (O) respectively;

Tᵣ: room temperature;

Tᵢ: temperature of ice;

Cᵢ is the specific heat of ice cubes and C_{L} is the latent heat required for ice cubes to change to water; and

C_{W} is the specific heat of water.

According to ingredients of dough, the total weight of the ice cubes and cold water is equal to a percent of the weight of flour.

(I+W)=aF (2)

where a is the percent, which is usually equal to 0.6.

The total electric energy (E) inputted to the bowl motor 11 and the mixer motor 12 can be obtained from a total energy required for optimally mixing all ingredients of a known dough recipe. If the dough recipe is new, the total energy for mixing all ingredients of the dough recipe should be proportional to the weight of flour.

E=bF (3)

where b may be a pre-determined value given from manufacturer's test results upon shipment. As the remaining parameters are known, by combining the foregoing three equations and using the temperature sensor 22 to measure the room temperature Tᵣ, the weights of ice cubes and water can be obtained from the following equations.

$$\begin{matrix}I = \frac{bF - [ {MC}_{M} + {FC}_{F} + {OC}_{O} + {aFC}_{W} ] ( {T}_{f} - {T}_{r} )}{{C}_{i} ( {T}_{f} - {T}_{i} ) + {C}_{L} - {C}_{W} ( {T}_{f} - {T}_{r} )} & ( 4 ) \\ W = aF - 1 & ( 5 )\end{matrix}$$

Hence, operation personnel just needs to use the dough-mixing control device 20 to calculate the weights of ice cubes and water and add ice cubes and water respectively corresponding to the calculated weights thereof, thereby obtaining the desired final temperature of dough. The temperature sensor 22 can always monitor the temperature of the piece of dough 30 during dough mixing. If the temperature is higher than the optimal temperature T_{f}, an alert is issued to notify operation personnel to pay attention to the temperature of the piece of dough 30.

The dough gluten development determination step determines if an actual total mixing time exceeds a maximum mixing time (Step 104), determines if the actual total mixing time and an actual total mixing energy of the piece of dough 30 fall within a range of an optimal total mixing time and a range of an optimal total mixing energy controlled by a range factor (Step 105), and determines if the piece of dough 30 reaches its optimal gluten development (Step 106). When the protein inside the piece of dough 30 is fully spread, the ductility and elasticity of the piece of dough 30 are the greatest and the power consumed by the mixer motor 12 and the bowl motor 11 all reach their maximum values.

In reality, the piece of dough 30 is an inhomogeneous, sticky and elastic material. During a dough mixing process, the mixer 14 continuously, rapidly and repeatedly contacts, kneads, squeezes and separates itself from the piece of dough 30. Because the state of the piece of dough 30 dramatically changes at any moment, the signals of current and power consumed by the mixer 14 may fluctuate in a wide range. Suppose that an approach using an existing maximum value to update the signals of current and power is adopted.

If f(t)>fₘₐₓ, then fₘₐₓ=f(t)

where t represents a certain time, and f represents measured current or power at the certain time.

A peak value can be identified through the above equation. However, it is impossible to predict whether a next measured value is higher than a present peak value or not. Therefore, the overall condition of the piece of dough 30 fails to be accurately reflected, and a present peak value cannot be instantly determined if it is a maximum value of the entire dough mixing process.

Using the moving average concept to develop a moving average ratio can be the approach best identifying the condition of the piece of dough 30 and predicting if a maximum value has been reached. To get an overall condition of the piece of dough 30 and screen out significant variations, an average value of current or power within a preset period is first acquired.

$${f}_{avg} ( k ) = \frac{{\sum }_{i = 1}^{n} {f}_{i} ( t )}{n} \qquad ( 7 )$$

where n is a sample number within the preset time, and k is the times of obtaining the average value.

To determine if the average values are on the rise, staying at a peak period or on the decline, the moving average concept is employed to determine if a ratio of power consumed within two adjacent preset periods has reached a maximum value.

$$\begin{matrix}r ( k ) = \frac{{f}_{avg} ( k )}{{f}_{avg} ( k - 1 )} & ( 8 ) \\ {r}_{avg} ( k ) = \frac{r ( k ) + r ( k - 1 ) + r ( k - 2 ) + … + r ( k - m + 1 )}{m} & ( 9 )\end{matrix}$$

where r(k) is the ratio of the k-th average value over the (k−1)-th average value, and r_{avg}(k) is the m-th moving average value of r(k).

If the protein of the piece of dough 30 is still underdeveloped, r(k) or r_{avg} (k) is greater than 1, it indicates that the trend of the current or power is on the rise. If r(k) or r_{avg}(k) is approximately equal to 1, it indicates that the piece of dough 30 has reached its peak period and the piece of dough 30 with optimal ductility and elasticity can be obtained by immediately stopping the dough mixing. If r(k) or r_{avg}(k) is less than 1, it indicates that the trend of consumed current or power is on the decline and the quality of the piece of dough 30 is deteriorating for the sake of being over-mixed and having broken protein bonds. As to r(k) and r_{avg}(k),r_{avg}(k) shows a more stable and uniform variation and can serve as a better basis for determination. Such determination method allows operation personnel to select the elasticity of dough (or Q, let Q=r_{avg}). If intending to make European bread with high elasticity, operation personnel should set the value of Q in a range of 1˜1.05 during the parameter configuration and stop dough mixing when r_{avg}(k) falls within the range of 1˜1.05, indicating that the dough with fully developed gluten is obtained. If sweet bread (for example, red bean bread) is to be made, soft but elastic dough should be prepared and the value of Q should be set in a range of 1.1˜1.15 during the parameter configuration, and dough mixing should be stopped when r_{avg}(k) falls within the range of 1.1˜1.15, indicating that the dough is not fully developed yet but is soft and elastic and is good for the making of sweet bread.

The dough gluten development determination step is proved to be effective after the dough-mixing device 10 is tested with the foregoing dough temperature determination step for numerous times. However, in the case of mixing small dough (for example: dough weighing 5 kg is mixed once at a time by a dough mixer with a 22 kg capacity), the success rate goes down because the signal level of consumed current or power is relatively small in comparison with those of varying noises. To ensure that the dough-mixing device 10 acquires the piece of dough 30 in an optimal or quasi-optimal condition and is adjustable according to operation personnel's preference, the statistical production control step is used.

The statistical production control step controls the optimal total mixing time and the optimal total mixing energy, records these two values in the memory module 24 every time after the dough mixing is finished, and automatically and statistically calculates their average values for the purpose of production control when an identical recipe is repeatedly used later.

Setting the mixing time is the most straightforward control means for operation personnel to control the dough-mixing device 10. However, there are many factors possibly affecting the mixing of the piece of dough 30. Using the mixing time alone may not be sufficient to control the dough-mixing device 10. Regarding the setting of mixing time, conventional dough mixers only has three stages for mixing time setup. To mix the piece of dough 30 more evenly without sticking on an inner wall of the mixing bowl 13, the dough-mixing device 10 of the present invention adds one additional stage, that is, a second slow forward rotation, to provide four stages in sequence for mixing time setup corresponding to a period (t₁) for a first slow forward rotation, a period (t₂) for a slow reverse rotation, a period (t₃) for the second slow forward rotation and a period (t₄) for a fast forward rotation. As the piece of dough 30 is a sticky and elastic material, the mixing resistance force is proportional to the mixing speed. Besides, the input energy for dough mixing is equal to the multiplication of the mixing resistance force, the mixing speed and the mixing time. Hence, the total mixing time (t) of the piece of dough 30 can be expressed as follows:

$${t}_{t} = \frac{{t}_{1} + {t}_{2} + {t}_{3}}{{r}^{2}} + {t}_{4} \qquad ( 10 )$$

where r is a ratio of the speed of the fast forward rotation over the speed of the slow rotation, and the above equation is therefore used to calculate an equivalent total (fast) mixing time.

The total mixing energy is determined by a mixing condition of the piece of dough 30 and is positively correlated with the inputted mixing energy. Hence, the mixing energy for the piece of dough 30 to be developed to its optimal condition is used to facilitate the production control, and a method is addressed by measuring a power signal and taking an integral of the power signal to obtain the mixing energy. A sum of energy obtained from the mixing energy during the foregoing four stages is the total mixing energy, that is, the total inputted electric energy (E) in Eqn. (1).

After each dough mixing process is completed, the statistical production control step displays the total mixing time in the four stages and total mixing energy. After operation personnel makes slight adjustment according to a difference between an actual status and an optimal status of the piece of dough 30, the total mixing time calculated by Eqn. (10) is taken as an optimal total mixing time, and a calculated total mixing energy in four stages is taken as an optimal total mixing energy. The optimal total mixing time and the total mixing energy are stored in data columns for a corresponding dough recipe in the MCU 23. When operation personnel needs to use the dough recipe later on, the MCU 23 takes an average of each of the optimal total mixing time and the optimal total mixing energy at several previous occasions (configurable) and then deducts and adds a range factor c from and to each of the two values to generate a control range for the current dough mixing process. In other words, the total mixing time or the total mixing energy of the current dough mixing process should fall within a tolerance range of the optimal total mixing time or the optimal total mixing energy by applying the range factor c as a tolerance to the average value of the optimal total mixing time and the optimal total mixing energy. For example, if the range factor c is equal to 10%, each dough mixing process should at least spend 90% of the average value of the optimal total mixing time or the optimal total mixing energy, whichever comes first (or last); the dough mixing process should be stopped when it spends more than 110% of the average value of the optimal total mixing time or the optimal total mixing energy, whichever comes last (or first).

When the dough mixing process spends the total mixing time or the total mixing energy within the control range, the dough mixing process can be stopped at an appropriate timing according to the dough gluten development determination step. Hence, if the dough gluten development determination step is inapplicable, an error between the mixing time or energy of the piece of dough 30 and that of the dough optimally calculated by statistics should fall within the tolerance range c. Besides, the determination of the value of Q of the piece of dough 30 can be effectively combined with operation personnel's experience.

An initial value of the total mixing time can be obtained by the following equation after using the dough gluten development determination step and the statistical production control step to test for the optimal total mixing time.

tₜ=t₀+dF+eO

where F and O are the weights of flour and oil, t₀ is a basic time for dough mixing, and d and e are two related coefficients.

The latter three parameters can be determined by linear regression of experiment data of many tests prior to shipment of the dough mixer. The initial value of the optimal total mixing energy E is determined by Eqn. (3), which is uncorrelated with oil because oil reduces the resistance force in dough mixing but increases the mixing time. Therefore, due to the insignificance to the total mixing power, the effect of oil is not taken into account.

From the foregoing, the optimal gluten development of the piece of dough 30 can be obtained by detecting the mixing temperature and the gluten development of the piece of dough 30 and performing a statistical calculation to ensure that the gluten development and quality of the piece of dough 30 can be consistent without causing unstable quality of dough. Accordingly, high production cost of dough arising from determination of dough gluten development with human experience, and the ineffectiveness of determining the state of dough can be resolved.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A dough-mixing control method capable of determining dough gluten development, comprising:
a dough gluten development determination step determining if a moving average ratio of average current or power has reached its maximum where the average current or power is consumed by a dough mixer while mixing a piece of dough, and if positive, further determining that an optimal condition of dough gluten of the piece of dough has been reached; and
a statistical production control step recording or calculating an optimal total mixing time and an optimal total mixing energy associated with a dough recipe, wherein the optimal total mixing time is equal to a calculated sum of multiple mixing periods corresponding to multiple mixing speed stages in the dough mixing process, and the optimal total mixing energy is equal to a sum of power consumed in the mixing speed stages in the dough mixing process.

2. The method as claimed in claim 1, further comprising a dough temperature determination step first calculating heat and temperature during the dough mixing process and further calculating a weight of added ice cubes and a weight of added cold water before the dough gluten development determination step by following equations:
$$1 = \frac{bF - [ {MC}_{M} + {FC}_{F} + {OC}_{O} + {aFC}_{W} ] ( {T}_{f} - {T}_{r} )}{{C}_{i} ( {T}_{f} - {T}_{i} ) + {C}_{L} - {C}_{W} ( {T}_{f} - {T}_{r} )} ;$$
$$W = a F - 1 ;$$
where
F is a weight of flour;
O is a weight of oil;
M is a weight of a mixer and a mixing bowl of the dough mixer;
C_{M} is a specific heat of a stainless steel material of the mixer and the mixing bowl;
C_{F} and C_{O}: are specific heats of flour and oil respectively;
Tᵣ is room temperature;
Tᵢ is temperature of ice;
Cᵢ is a specific heat of ice and C_{L} is a latent heat required for ice to change to water;
C_{W} is a specific heat of water;
I is a weight of ice cubes;
a is a percent; and
b is a pre-determined value.

3. The method as claimed in claim 1, wherein the dough gluten development determination step is expressed by following equations:
$$r ( k ) = \frac{{f}_{avg} ( k )}{{f}_{avg} ( k - 1 )} ;$$
$${r}_{avg} ( k ) = \frac{r ( k ) + r ( k - 1 ) + r ( k - 2 ) + … + r ( k - m + 1 )}{m} ;$$
where r(k) is a ratio of a k-th average current or power value over a (k−1)-th average current or power value, and r_{avg}(k) is an m-th moving average of r(k);
if r(k) or r_{avg}(k) is greater than 1, it indicates that a trend of the current or power is on the rise;
if r(k) or r_{avg}(k) is approximately equal to 1, it indicates that the piece of dough has reached a state with optimal ductility and elasticity; and
if r(k) or r_{avg}(k) is less than 1, it indicates that the piece of dough is over-mixed.

4. The method as claimed in claim 2, wherein the dough gluten development determination step are expressed by following equations:
$$r ( k ) = \frac{{f}_{avg} ( k )}{{f}_{avg} ( k - 1 )} ;$$
$${r}_{avg} ( k ) = \frac{r ( k ) + r ( k - 1 ) + r ( k - 2 ) + … + r ( k - m + 1 )}{m} ;$$
where r(k) is a ratio of a k-th average current or power value over a (k−1)-th average current or power value, and r_{avg}(k) is an m-th moving average of r(k);
if r(k) or r_{avg}(k) is greater than 1, it indicates that a trend of the current or power is on the rise;
if r(k) or r_{avg}(k) is approximately equal to 1, it indicates that the piece of dough has reached a state with optimal ductility and elasticity; and
if r(k) or r_{avg}(k) is less than 1, it indicates that the piece of dough is overmixed.

5. The method as claimed in claim 3, further comprising a parameter configuration step setting up multiple mixing periods to correspond to multiple mixing speeds, wherein the mixing periods include a mixing period corresponding to a first slow forward rotation (t₁), a mixing period corresponding to a slow reverse rotation (t₂), a mixing period corresponding to a second slow forward rotation (t₃) and a mixing period corresponding to a fast forward rotation (t₄), and the total mixing time (tₜ) is expressed as follows:
$${t}_{t} = \frac{{t}_{1} + {t}_{2} + {t}_{3}}{{r}^{2}} + {t}_{4}$$
where r is a ratio of a speed of a speed of the fast forward rotation over a speed of the first slow forward rotation.

6. The method as claimed in claim 4, further comprising a parameter configuration step setting up multiple mixing periods to correspond to multiple mixing speeds, wherein the mixing periods include a mixing period corresponding to a first slow forward rotation (t₁), a mixing period corresponding to a slow reverse rotation (t₂), a mixing period corresponding to a second slow forward rotation (t₃) and a mixing period corresponding to a fast forward rotation (t₄), and the optimal total mixing time (tₜ) is expressed as follows:
$${t}_{t} = \frac{{t}_{1} + {t}_{2} + {t}_{3}}{{r}^{2}} + {t}_{4}$$
where r is a ratio of a speed of a speed of the fast forward rotation over a speed of the first slow forward rotation.

7. The method as claimed in claim 1, wherein
each of the optimal total mixing time and the optimal total mixing energy has a range factor serving as a tolerance deducted therefrom and added thereto to constitute a tolerance control range; and
the dough gluten development determination step determines if an actual total mixing time and an actual total mixing energy fall within the tolerance control range.

8. The method as claimed in claim 2, wherein
each of the optimal total mixing time and the optimal total mixing energy has a range factor serving as a tolerance deducted therefrom and added thereto to constitute a tolerance control range; and
the dough gluten development determination step determines if an actual total mixing time and an actual total mixing energy fall within the tolerance control range.

9. The method as claimed in claim 3, wherein
each of the optimal total mixing time and the optimal total mixing energy has a range factor serving as a tolerance deducted therefrom and added thereto to constitute a tolerance control range; and
the dough gluten development determination step determines if an actual total mixing time and an actual total mixing energy fall within the tolerance control range.

10. The method as claimed in claim 4, wherein
each of the optimal total mixing time and the optimal total mixing energy has a range factor serving as a tolerance deducted therefrom and added thereto to constitute a tolerance control range; and
the dough gluten development determination step determines if an actual total mixing time and an actual total mixing energy fall within the tolerance control range.

11. The method as claimed in claim 5, wherein
each of the optimal total mixing time and the optimal total mixing energy has a range factor serving as a tolerance deducted therefrom and added thereto to constitute a tolerance control range; and
the dough gluten development determination step determines if an actual total mixing time and an actual total mixing energy fall within the tolerance control range.

12. The method as claimed in claim 6, wherein
each of the optimal total mixing time and the optimal total mixing energy has a range factor serving as a tolerance deducted therefrom and added thereto to constitute a tolerance control range; and
the dough gluten development determination step determines if an actual total mixing time and an actual total mixing energy fall within the tolerance control range.

13. A dough-mixing control device capable of determining dough gluten development, the dough-mixing control device mounted on a dough mixer and comprising:
a power sensor adapted to detect current or power consumed by a bowl motor and a mixer motor of the dough mixer;
a temperature sensor adapted to detect temperature of a piece of dough inside a mixing bowl of the dough mixer;
a micro-controller unit (MCU) connected to the power sensor and the temperature sensor and having a dough gluten development determination procedure built therein, wherein the dough gluten development determination procedure determines dough gluten development using multiple parameters and multiple gluten development determining steps to convert the gluten development into a control signal, the parameters include recipe, weight, mixing time, mixing speed and optimal temperature for the dough, and the gluten development determining steps include a parameter configuration step, a dough temperature determination step, a dough gluten development determination step and a statistical production control step, wherein the parameter configuration step sets the recipe, weight, mixing time, mixing speed and elasticity of the piece of dough, the dough temperature determination step calculates heat and temperature of the piece of dough when the piece of dough is mixed to determine if the temperature of the mixed piece of dough exceeds the optimal temperature value, the dough gluten development determination step determines if an average current or power reaches a maximum value, the statistical production control step records an optimal total mixing time and an optimal total mixing energy for a dough recipe and controls an actual total mixing time or an actual total mixing energy within a range of the optimal total mixing time or the optimal total mixing energy;
a memory module connected to the MCU and serving to record the parameters and the gluten development determining step of the dough gluten development determination procedure;
an output module receiving a control signal of the MCU and controlling the mixer motor to operate according to the control signal; and
an operation module used to select or input each parameter and send it to the MCU, or displaying the control signal of the MCU, or the consumed current or power detected by the power sensor.
